(19) United States
(12) Patent Application Publication
(10) Pub. No.: US 2016/0038886 A1
(43) Pub. Date: Feb. 11, 2016

(54) Sulfur-Resistant Palladium or Palladium Alloy Membranes for Hydrogen Separation

(71) Applicants: Shigeo Ted Oyama, Blacksburg, VA (US); Samhun Yun, Anyang-ci (KR); Sheima J. Khatib, Benalmadena Costa (ES)

(72) Inventors: Shigeo Ted Oyama, Blacksburg, VA (US); Samhun Yun, Anyang-ci (KR); Sheima J. Khatib, Benalmadena Costa (ES)

(21) Appl. No.: 14/819,225

(22) Filed: Aug. 5, 2015

Related U.S. Application Data
(60) Provisional application No. 62/033,138, filed on Aug. 5, 2014.

(51) Int. Cl. B01D 71/02; B01D 67/00; B01D 53/22

(52) U.S. Cl. CPC B01D 71/02; B01D 53/228; B01D 67/0069

(57) ABSTRACT

The present invention provides composite membranes consisting of palladium and palladium alloys with a phosphorus component. The membranes may be used in a tubular geometry on an alumina support. In other embodiments, the membranes may be prepared by treating the metal precursor with a phosphorus source such as phosphine.

### RELATED APPLICATIONS

This application claims the benefit of U.S. Provisional Application No. 62/033,138 filed Aug. 5, 2014 and herein incorporated by reference.

### STATEMENT REGARDING FEDERALLY SPONSORED RESEARCH & DEVELOPMENT

This invention was made with government support under DE-FG02-96ER14669 awarded by the Department of Energy. The government has certain rights in the invention.

### INCORPORATION BY REFERENCE OF MATERIAL SUBMITTED ON A COMPACT DISC

Not applicable.

### BACKGROUND OF THE INVENTION

The conversion of fossil fuels, possibly combined with biomass, by gasification, reforming, or partial oxidation processes is important for the synthesis of hydrogen and syngas for subsequent use in refining, or chemicals and fuel production. In the implementation of these technologies, gas-separation steps are needed, most importantly for the generation of hydrogen. One of the methods for gas separation is membrane technology. In particular, the use of membrane reactors is a promising application because the combination of reaction and separation can be used to overcome equilibrium limitations in some chemical transformations. Robust membranes are necessary for these conversion processes since they are carried out at severe conditions of pressure and temperature, and often in the presence of noxious and corrosive gases. Palladium-based membranes are effective materials for hydrogen separation with high permeance and selectivity and high mechanical strength. However, a challenging problem with palladium membranes is their susceptibility to poisoning by sulfur. Sulfur poisoning is a significant hazard with some feedstocks, for example those derived from coal and even small amounts of sulfur compounds in the feed, as in the case of bio-derived resources, can lead to deactivation of these membranes after exposure. Sulfur tolerance is an important attribute of palladium membranes. The US. Department of Energy has set tolerance to a level of 100 ppm H₂S as a target for practical membranes.

Palladium membranes suffer other disadvantages. The metal is expensive, so membranes cannot be fabricated in large scales. The metal also undergoes a phase transition at 573 K with an accompanying volume change that deteriorates the mechanical properties of the membranes. The phase transition involves an α-phase (hydrogen-rich) and a β-phase (Pd-rich) both of which have the fcc structure but different crystal lattice parameters.

These disadvantages can be overcome by alloying palladium with other elements, since this both minimizes the amount of palladium used and also lowers the temperature of the phase transition. Moreover, studies have reported that Pd alloys with Ce, Cu, Au, Ag can exhibit higher permeability values than each of the metals individually, as well as improved resistance to sulfur poisoning. Therefore Pd alloys can lower the cost of the membranes as well as increase the membrane performance, promote chemical stability and increase mechanical resistance.

A palladium alloy that has been studied for membrane systems and that was commercialized successfully in the 1960s is the palladium-silver system. The alloy shows enhanced permeance over pure palladium. When studying the chemical stability of Pd—Ag membranes in the presence of H₂S, it has been found that in the case of a 73 wt % Pd—Ag tube with −75 pm of wall thickness, at 773 K and 200 psi, the Pd—Ag membrane exhibited negligible changes in flux at 490 and 1280 ppm of H₂S; however there was a dramatic permeance loss at 1600 ppm of H₂S. When exposed to 1500 ppm H₂S for 16 hours, a palladium sulfide layer was formed on the surface of the membrane. In all the cases, the poisoned membrane could be regenerated by exposure to pure hydrogen for 24 hours at 773 K. Others have obtained similar results in the Pd—Ag system, where the membrane performance dropped 50% in 16 hours at 773 K in the presence of 1600 ppm of H₂S. Others have studied the influence of H₂S on −μm 25 palladium-alloy foils at 623 K and 75 psig of feed pressure, using a H₂S concentration range of 3.5-4.7 ppm. In the case of 73 wt % Pd—Ag alloy, the membrane lost most of its permeance within the first 6 hours of exposure, and 99% in 6 days of studied exposure. The membrane could be partially regenerated if H₂S was removed from the system after 2 days of exposure (80% reduction in flux from the pre-H₂S exposure). Others have also studied the chemical stability of palladium alloys where the foils were −25 μm thick, at 773 K in hydrogen at −115 psia. In the case of the 75 wt % Pd—Ag alloy a permeance drop of 99% was observed when exposed to 50 ppm H₂S and no detectable hydrogen flux at 1000 ppm of H₂S. Other have studied the performance of Pd—Ag membranes in the presence of various chemical species such as toluene, methyl-cyclohexane, chlorine and sulfur. A reduction of −83% in performance was observed at 906 K in the presence of 1630 ppm of sulfur. The membrane was regenerated in air and thus this explained the behavior of the membrane to blocking of dissociation sites for hydrogen adsorption on the membrane surface.

Others have a prepared a 75 mol % Pd—Ag membrane and observed a dramatic loss in hydrogen permeation along with the formation of a ternary Ag₅Pd₁₀S₅ phase on the membrane surface when it was exposed to 100 ppm H₂S in 80% H₂—He at 593 K.

One of the disadvantages of the Pd—Ag alloys is their high cost and their tendency to be poisoned by sulfur-containing gases. Therefore, considerable work has been done with Pd—Cu membranes because Cu is not as costly a material as Ag and Pd—Cu alloys do not show embrittlement even at low temperatures. A possible explanation of the higher resistance to sulfur poisoning of Pd—Cu alloys is found in studies on the effect of addition of Cu to the surface of Pd on the adsorption of H₂S and concluded that Pd has a higher affinity to H₂S than Cu. It was found that the H₂S binding trend is Cu<Pd<Nb. Studies confirm these results for Pd—Cu compositions of 8, 18, and 19 wt % Cu, with permeance losses of 80% at 500° C. (773 K). They further showed that the loss was partially reversible by hydrogen treatment. It has also been found that Pd and Pd—Cu (20-65 wt % Cu) composite membranes ruptured at 723 K during exposure to H₂S gas mixtures with concentrations above 100 and 300 ppm, respectively. It was explained that sulfidation of pure Pd and Pd—Cu alloys increased the lattice parameters by 67% and 250%, respectively, which led to membrane failure. Studies also examined the sulfidization of Pd and Pd—Cu (30 mol % Cu) membranes with different H₂S to H₂ partial pressure ratios and predicted the maximum concentration of H₂S for stable operation of the membrane systems without sulfidization using thermodynamic calculations. Both calculations and experimental results suggested that the Pd or Pd—Cu membrane systems could be stably run at 1173 K in the presence of H₂S up to 1100 ppm. It has also been reported that the H₂ permeance of Pd—Cu (40 wt % Cu) composite membranes showed a good sulfur resistance in the temperature range of 573-673 K but the permeances decreased rapidly below 573 K in the presence of a 100 ppm H₂S gas mixture. The decrease in hydrogen permeance at low temperature is attributed to the decrease of hydrogen solubility in the membranes due to adsorption of H₂S on the surface of the Pd—Cu alloys under those conditions.

The influence of adsorbed sulfur on surface segregation in a Pd—Cu membrane (30 at % Cu) was reported. It was observed that no Cu atoms were found in the topmost layer of the alloy surface with adsorbed sulfur due to the segregation induced by thermodynamically favored Pd—S bonds at the surface. Studies reported that the hydrogen permeance of Pd and Pd—Ag (25 wt % Ag) membranes rapidly decreased by greater than two orders of magnitude with 20 ppm H₂S at 593 K but the permeance of Pd—Cu (20 wt % Cu) decreased by less than one order of magnitude at identical conditions. The Pd—Cu alloy exhibited a bounce in H₂ permeability from 60% to 80% of the initial value during exposure to the H₂S gas mixture, which implied that the layer was broken or Pd—Cu-sulfide retained some catalytic activity for H₂ dissociation. Another study shows that Pd exposed to 1000 ppm sulfur at 350° C. (623 K) corrodes over a period of hours to form a thick (6.6 um) PdS₄ layer, probably by an autocatalytic process. In contrast a Pd₄₇Cu₅₃ alloy forms a thin (˜3 nm) Pd—Cu—S layer. Although this layer cannot dissociate hydrogen or is impermeable to hydrogen, it does protect the bulk from sulfidation, and could be removed by a hydrogen treatment.

The sulfur resistance of Pd—Cu alloys was reported and it was shown that the face-centered cubic (fcc) phase is more resistant to sulfur than the body-centered cubic (bcc) phase. In transient experiments, the fcc Pd—Cu composition showed a decline of 0-10% when exposed to 1000 ppm of sulfur, while a bcc Pd—Cu composition had a decline of 99%. But the Pd—Cu membrane which has the fcc structure has lower permeance than the membrane with the bcc structure, showing only 20% of the H₂ permeance of pure Pd. Others prepared ceramic-supported Pd—Cu membranes by deposition of Pd and Cu using sequential electroless plating followed by annealing to alloy the metals. It was found that two support structural factors affect the performance of the membrane. Firstly, the top layer pore size determines the metal film thickness necessary to prevent leaking of the inert gas, so the larger the pore size, the larger the thickness of the layer necessary to ensure lack of leaking. Secondly, an asymmetric support, made of increasing coarser layers, presents lower resistance to the flow, yielding a higher H₂ flux if compared with a symmetric one. They produced a palladium/copper composite membrane with average metal thickness of 1.5 pm. The H₂ flux of the 11 pm thick Pd—Cu film was 0.8 mol m⁻²s⁻¹ at 450° C. with H₂/N₂ separation factor of 1150 at a pressure of 345 kPa.

### BRIEF SUMMARY OF THE INVENTION

An object of the present invention is to provide new Pd-related composite materials with good sulfur resistance. In one embodiment of the present invention, the heat of formation and Gibbs free energy of principal binary compounds of sulfur with most of the elements in the periodic table were examined to find which have the least probability to form sulfur compounds (FIG. 1). As seen in the table, the heat of formation of P₄S₃ is −155 kJ mol⁻¹, which corresponds to −39 kJ mol⁻¹ per atom of P. All the neighbors of phosphorus have higher values, for example, Si has −107 kJ mol⁻¹ per atom. Ge has −69 kJ mol⁻¹ per atom. As has −84.5 kJ mol⁻¹ per atom. These values indicate that P is the least likely to form a sulfur compound among the main group elements and is therefore a preferred material for the embodiments of the present invention as a result of its strong sulfur resistance.

In other embodiments of the present invention, candidates to alloy with Pd were also chosen through examination of the heat of formation of the transition metal sulfides, which may also be used with certain embodiments of the present invention. The elements to the left in the periodic table (FIG. 1) have very large values, for example, Sc shows −492 kJ mol⁻¹ per atom and Ti −336 kJ mol⁻¹ per atom. The general trend is for the heats of reaction to decrease (become less negative) on moving to the right among the transition metals with exceptions due to partial filling of the d-subshells (d5 and d10) and due to changes in bonding type (from ionic to covalent). The elements that show the lowest heats of sulfidation are Cu, with −40 kJ mol⁻¹ per atom, and Ag, with −16.3 kJ mol⁻¹ per atom, while Pd has a relatively high heat, with −75 kJ mol⁻¹. Therefore alloys of Pd with these two metals were considered as suitable mixed-metal membranes with phosphorus. Phosphorus forms the compound P₄S₃, whose heat per mole of P is low, (155/4=−39 kJ mol⁻¹).

In other embodiments, the present invention provides novel composite membranes consisting of palladium and palladium alloys with a phosphorus component used in a tubular geometry on an alumina support. In other embodiments, the membranes may be prepared by contacting palladium and palladium alloys with PH₃ as a gaseous phosphorus source. As will be shown, the addition of phosphorus imparts sulfur resistance to the palladium membranes.

In yet other embodiments, the present invention provides materials and methods of preparation of sulfur-tolerant membranes based on palladium or palladium alloys. The compositions consist of the palladium or palladium alloys combined with phosphorus to form phosphides. The method consists of treatment of the metal precursor with a phosphorus source such as phosphine.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 shows the heat of formation of binary sulfur compound. Units: kJ mol⁻¹.

FIG. 2 is a schematic of one embodiment of the present invention for the PH₃ treatment and evaluation of the membranes.

FIG. 3 is a plot of H₂ permeance versus time for the Pd and Pd—P membranes.

FIG. 4 is a plot of H₂ permeance versus time for the Pd—Ag and Pd—Ag—P membranes.

FIG. 5 is a plot of H₂ permeance versus time for the Pd—Cu and Pd—Cu—P membranes.

FIG. 6 is a plot of H₂ permeance versus time for Pd—Cu and Pd—Cu—P membranes with longer time of exposure to H₂S.

FIGS. 7A-7F show SEM images of the surface of the Pd membranes with PH₃ treatment and without PH₃ treatment after exposure to H₂S gas mixture: (7A) Pd, (7B) Pd—P. (7C) Pd—Ag, (7D) Pd—Ag—P, (7E) Pd—Cu, and (7F) Pd—Cu—P.

FIGS. 8A-8B (8A) XRD pattern of Pd and PdP. (8A) Expanded region and (8A) represents the α-Al₂O₃ support.

FIGS. 9A-9B XRD pattern of Pd—Ag and Pd—Ag—P. (9B) Expanded region and (9A) represents the α-Al₂O₃ support.

FIGS. 10A-10B (10A) XRD pattern of Pd—Cu and Pd—Cu—P. (10B) Expanded region and (A) represents the α-Al₂O₃.

FIG. 11 XPS spectra of membranes with P. before and after exposure to H₂S/H₂.

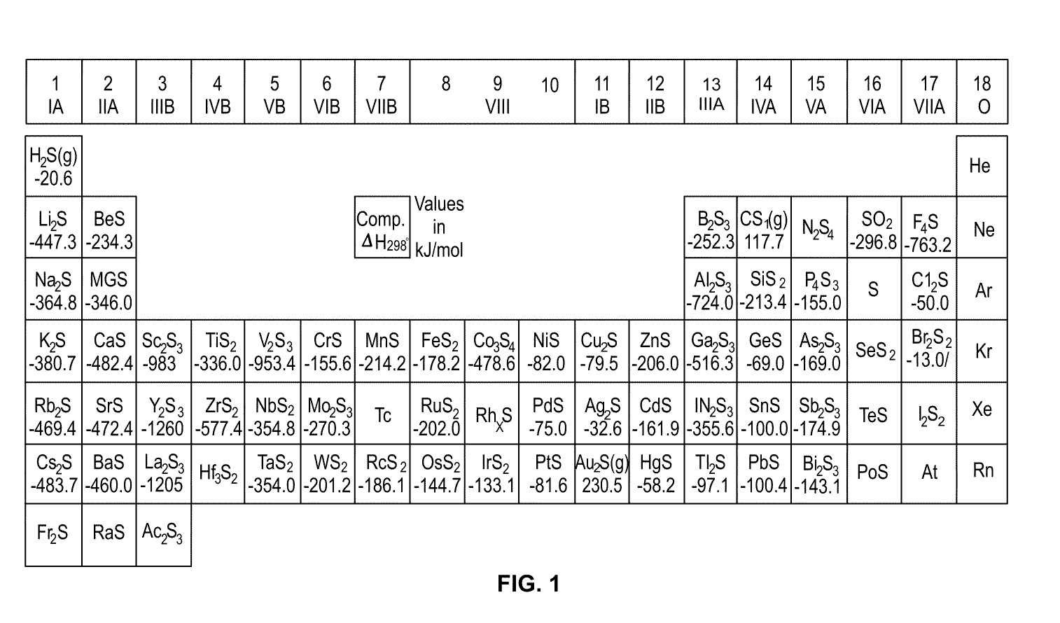

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

In one embodiment, the present invention may be implemented using porous hollow fiber α-alumina supports which may be asymmetric, as well as in other configurations. In one embodiment of the present invention, the outside surface of the support may be activated by an electric-field assisted activation. During the activation, an electric current is applied which may be 0.1 A, applied for 20 minutes at room temperature. Before the activation process, the outer surface may be conditioned by dipping into a 4 g 1⁻¹Pd solution. For some embodiments, the composition of the plating solution that may be used is shown in Table 1. In addition, the plating procedure may also include using a sonicator for 10 minutes, using a reducing agent composed of 0.5 M H₂N₄ and/or 1 M NaOH for 10 minutes which may also be administered sequentially at room temperature. This procedure induced a uniform formation of Pd nanoparticles in the activation. The activated surface was then plated with Pd, Pd—Ag or Pd—Cu layers by the electroless plating method using the plating solutions shown in Table 1.

TABLE 1
Composition of plating solutions used in the pre-
paration of palladium, palladium-silver, and copper
membranes.

| Component | Concentration | |
|---|---|---|
| Pd plating bath (328 K) | | |
| PdCl₂ | 4.0 | g l⁻¹ |
| NH₄OH (28 wt %) | 100 | ml l⁻¹ |
| Na₂EDTA | 40 | g l⁻¹ |
| N₂H₄ (1.0M)* | 6.0 | ml l⁻¹ |
| Pd₈₀Ag₃₀ plating bath (328 K) | | |
| PdCl₂ | 4.0 | g l⁻¹ |
| AgNO₃ | 2.6 | g l⁻¹ |
| NH₄OH (28 wt %) | 198 | ml l⁻¹ |
| Na₂EDTA | 40 | g l⁻¹ |
| N₂H₄ (1.0M)* | 6.0 | ml l⁻¹ |
| Cu plating bath (328 K) | | |
| CuSO₃•5H₂O | 30 | g l⁻¹ |
| Na₂EDTA | 60 | g l⁻¹ |
| HCHO (37 wt %)* | 25 | ml l⁻¹ |
| NaOH | 20 | g l⁻¹ |
| Tritron X-100 | 25 | mg l⁻¹ |
| 2,2-Hipyridyl | 5 | mg l⁻¹ |

*Added just before the use of each solution.

The Pd membrane was heated to 723 K, held for 3 hours, and cooled to 673 K under an Ar flow. The Pd-alloy membranes, Pd—Ag and Pd—Cu, were heated to 723 K, held for 3 hours, and cooled to 673 K under Ar flow, and then they were annealed at 873 K under Ar flow or at 673 K under H₂ flow for 10 hours.

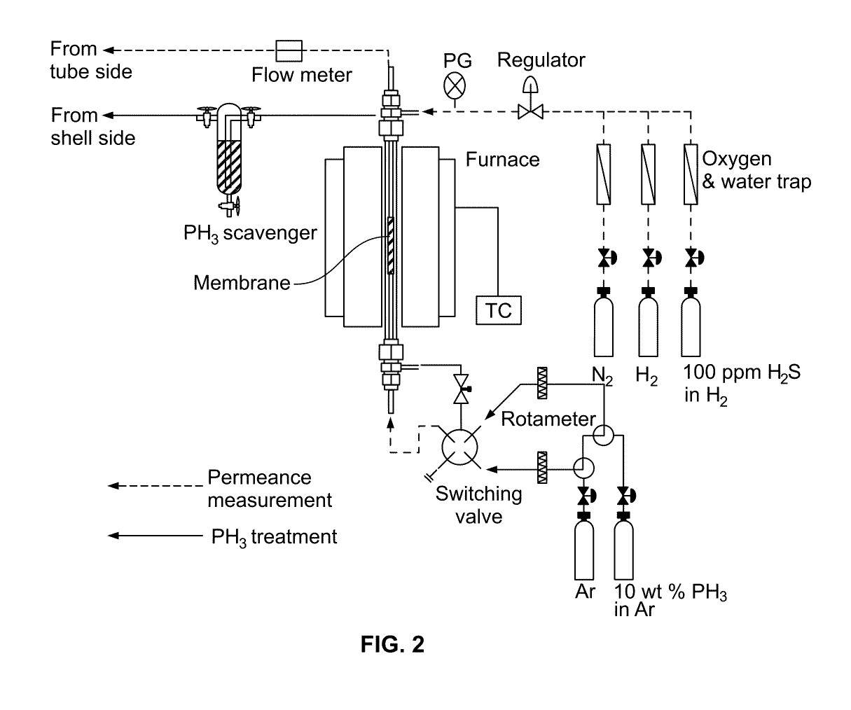

The incorporation of P in the membrane structure was carried out after measuring the H₂ and N₂ permeance of the membranes. These membranes were cooled to 473 K under Ar flow and treated with a 10 wt % PH₃ in Ar gas on the Pd layer to make the palladium phosphorus membrane as shown in FIG. 2.

The PH₃ gas mixture was flowed through the shell side of the membrane (outer surface) at a flow rate of 10 cm³ min⁻¹ for 10 minutes at 473 K to react with the Pd layer. The unreacted PH₃ gas was removed by the PH₃ scavenger solution comprising 0.4 M KMn0₄, 1 M H₂SO₄ and 0.01 M AgNO₃ before sending the remaining gas to a fume hood due to the high toxicity of PH₃ gas. After that the membranes were heated to 673 K under Ar flow for further evaluation.

In yet other embodiments, the present invention uses as the phosphorus source; diphosphine (P₂H₄), or red phosphorus, or a phosphate or phosphite compound, or any organic phosphine compounds such as trimethylphosphine, tryvinylphosphine, triphenyphosphine, or octyl phosphine.

The performance of the membranes prepared in accordance with the invention was evaluated by measuring the gas permeance at 673 K with a pressure difference of 105 kPa of pure H₂ and N₂ by measuring the flow rate of the gases passing through the membrane with a bubble flow meter. For the scanning electron microscopy (SEM) analysis, the membranes were first fractured to small pieces that were used as samples for the measurements. These pieces were cooled to room temperature under Ar flow and were introduced into the scanning electron microscope. The surface images were obtained using a LEO 1550 (Zeiss) instrument. XRD measurements were made with a PANalytical X'pert Pro powder diffractometer operated at 45 kV and 40 mA, using Cu Kα monochromatized radiation (λ=0.154178 nm). XPS measurements were performed on a PHI Quantera SXM instrument using Al Kα radiation, with 280 eV analyzer pass energy. No sputtering pretreatment was carried out. The hemispherical analyzer collected electrons with a takeoff angle of 45 degrees.

The evaluation of the sulfur resistance of the prepared membrane was tested by exposing the Pd layer to a gas mixture composed of 100 ppm H₂S in H₂ at 127 kPa and 673 K, for 40 minutes. During the experiment, the permeance of the H₂S gas mixture was measured at different times at 127 kPa to examine the dependence of permeance with time. After H₂S exposure, the membrane was regenerated by flowing H₂ at 673 K for 24 hours. The performance of the regenerated layer was evaluated by measuring the H₂S permeance and H₂/N₂ selectivity at 673 K.

The performance of the prepared membranes for some embodiments of the present invention (hydrogen permeance and hydrogen to nitrogen selectivity) is shown in Table 2.

TABLE 2
Membranes and permeance properties.

| | | | Rₐ permance (10⁶ mol m⁻² s⁻¹ Pa¹ H₂/N² selectivity at 273 K | | |
|---|---|---|---|---|---|
| | | Plating layer (member of plating*) | As-prepared | Exposure to 100 ppm H₂S | Flow H₂ for 248 |
| System | Membrane | Condition | membrane | for 40 mins at 127 kPa | at 100 kPa |
| Pd | Pd | Pd (2) | 40/18.000 | 20 | 63/46 |
| | | 34 kPa 323 K | | | |
| | Pd—P | Pd (3) | 54/2000 | 0.6 | 2.3/16 |
| | | 34 kPA 338 K | | | |
| Pd—Ag | Pd—Ag | Pd (1) + Pd₈₀Ag₂₀(1) | 53/55 | 0.3 | 5.0/3.7 |
| | | 101.3 kPa, 328 K, annealing at 873 K under Ar for 10 h | | | |
| | Pd—Ag—P | Pd (1) + Pd₈₀Ag₂₀(1) | 17/170.000 | 0.6 | 6.3/40.009 |
| | | 29 kPA 55° C. annealing at 873 K under Ar for 10 h | | | |
| Pd—Cu | Pd—Cu | Pd (2) + Cu (2) | 11.2/70.000 | 0.0 | 2.3/14.000 |
| | | 34 kPa, 55° C., annealing at 673 K under H₂ for 10 h | | | |
| | Pd—Cu—P | Pd (2) + Cu (2) | 52/30.000 | 0.57 | 6.5/45.000 |
| | | 34 kPa, 55° C., annealing at 673 K under H₂ for 10 h | | | |

*Plating under 40 min to 1 h.

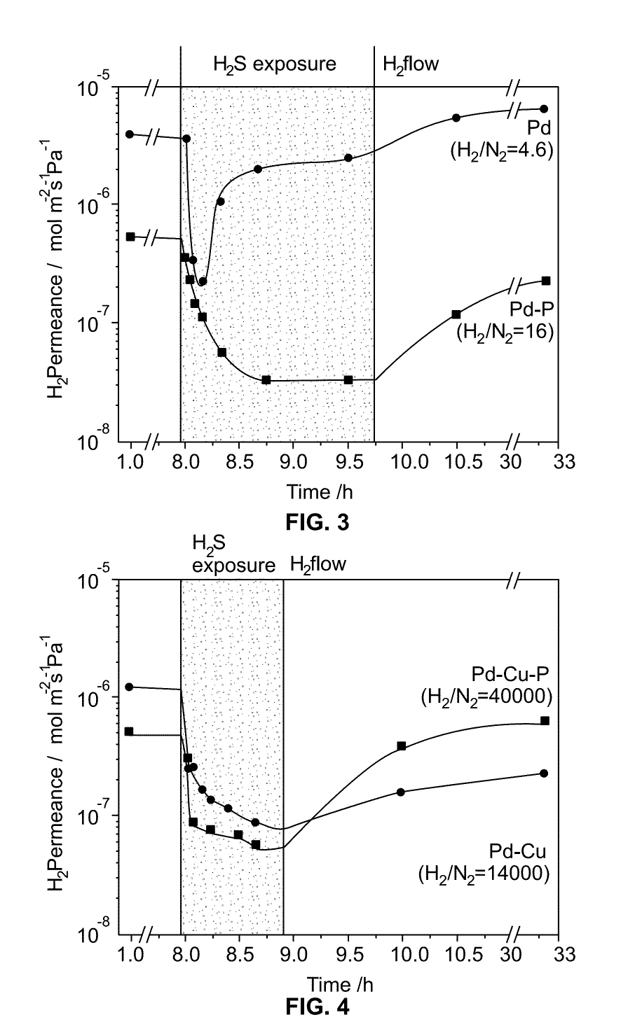

FIGS. 3-5 show the variation of the H₂ permeance with time at 673 K under exposure to H₂ and H₂S for other embodiments, Pd, Pd—Ag and Pd—Cu membranes. Each figure compares the results for each system or embodiment with and without PH₃ treatment.

As shown in Table 2, in the case of the Pd membrane, it is observed that the treatment with PH₃ makes the hydrogen permeance drop from 4.0×10⁻⁶ mol m⁻²s⁻¹Pa⁻¹ (Pd) to 5.4×10⁻⁷ mol m⁻²s⁻¹Pa⁻¹ (Pd—P) and the H₂/N₂ selectivity drop from 18,000 (Pd) to 2000 (Pd—P). FIG. 3 shows that during H₂S exposure, the hydrogen permeance of the Pd membrane initially drops but then rises, and after regeneration under hydrogen flow, it reaches an even higher value (6.3×10⁻⁶ mol m⁻²s⁻¹Pa⁻¹) than the permeance of the as-prepared membrane (4.0×10⁻⁶ mol m⁻²s⁻¹Pa⁻¹). The H₂/N₂ selectivity drops drastically to 4.6 with this treatment. These results indicate the formation of large defects in the membrane, probably in the form of cracks or orifices, which would explain the low selectivity, which approaches the Knudsen value of 3.7.

Very different results are obtained in other embodiments of the present invention which provide a Pd—Ag membrane. As shown in Table 2, the inclusion of P lowers the hydrogen permeance from 5.2×10⁻⁶ mol m⁻²s⁻¹Pa⁻¹ (Pd—Ag) to 1.7×10⁻⁶ mol m⁻²s⁻¹Pa⁻¹ (Pd—Ag—P) in the as-prepared membranes. However, there is a significant improvement in the selectivity which increases from 55 in Pd—Ag to 110,000 in Pd—Ag—P. FIG. 4 shows that during exposure to H₂S, the hydrogen permeance drops for both membranes and after treatment the in hydrogen flow recovers partially. There is also difference in selectivity between the Pd—Ag (3.7) and Pd—Ag—P (40,000) membranes after regeneration, while they both have practically the same hydrogen permeance value (5.9×10⁻⁷ mol m⁻²s⁻¹Pa⁻¹ and 6.3×10⁻⁷ mol m⁻²ₛ⁻¹Pa⁻¹ respectively.

Similarly, considerably different results are obtained in the case of the Pd—Cu membranes of the present invention. From the results shown in Table 2, it is observed that both Pd—Cu and Pd—Cu—P have a very high selectivity (70,000 and 30,000) and reasonable hydrogen permeance (1.1×10⁻⁶ mol m⁻²s⁻¹Pa⁻¹ and 5.2×10⁻⁷ mol m⁻²s⁻¹Pa⁻¹ respectively).

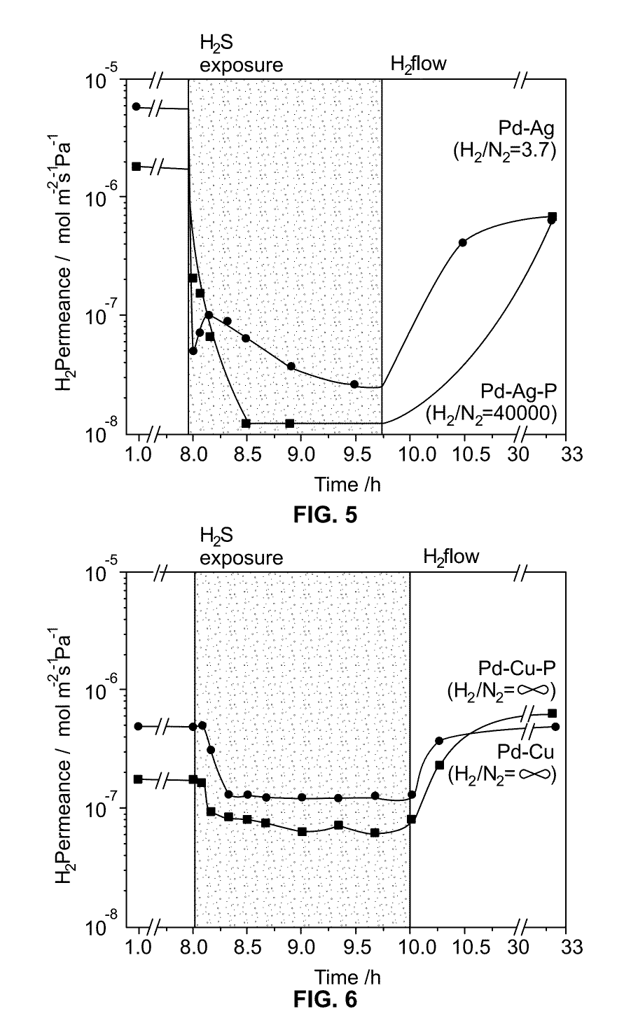

During H₂S exposure, the hydrogen permeance drops, as shown in FIG. 5. With hydrogen post-treatment, both membranes recover their hydrogen permeance.

In other embodiments, Pd—Cu—P membranes, after H₂S exposure and recovery in H₂, exhibit improved characteristics in both hydrogen permeance and H₂/N₂ selectivity. Both are enhanced compared to the as-prepared membrane from 5.2×10⁻⁷ mol m⁻²s⁻¹Pa⁻¹ to 6.5×10⁻⁷ mol m⁻²s⁻¹Pa⁻¹ and from 30,000 to 40,000 respectively. In other embodiments, another pair of Pd—Cu and Pd—Cu—P membranes were prepared and exposed to H₂S for a longer time and their recovery under H₂ was studied. The results are shown in FIG. 6, where it is observed that even after exposing these membranes to H₂S for over double of the previous time, the recovery process is equally effective, and once again the H₂ permeance and selectivity of the Pd—Cu—P membrane reaches higher values of H₂ permeance and selectivity after recovery compared to before H₂S exposure.

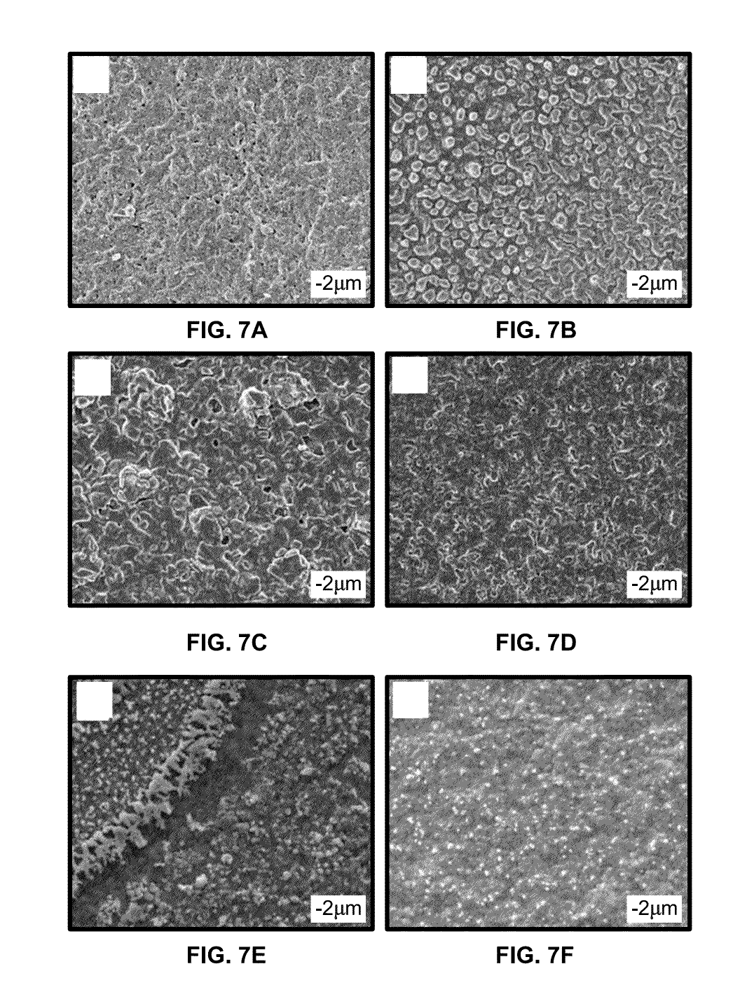

In order to study the physical changes of the surfaces of the membranes of the present invention, SEM images were obtained (with and without PH₃ treatment) after H₂S exposure with H₂ regeneration for the Pd, Pd—Ag and Pd—Cu systems and are shown in FIG. 7. Comparing the image for the Pd membrane (FIG. 7(a)) to the Pd—P membrane (FIG. 7(b)) it can clearly be observed that the Pd membrane presents a significantly higher number of fractures and pinholes, while the Pd—P membrane only exhibits some small pinholes.

The SEM images for the Pd—Ag membranes show that both membranes have pinholes, however the pinholes in the Pd—Ag—P (FIG. 7(d)) membrane are much smaller than in the Pd—Ag membrane (FIG. 7(c)), thus explaining the higher H₂/N₂ selectivity of the PH₃-treated membrane (Table 2).

The SEM images of the Pd—Cu system show that in the case of the Pd—Cu membrane the surface is not completely homogeneous. There are areas where there seem to be segregation of particles on the surface. The Pd—Cu—P membrane of an embodiment of the present invention presents a homogeneous surface with smaller particle sizes. Thus, it is generally observed from these results that the presence of P influences the final structure of the membranes after H₂S exposure and H₂ regeneration, by homogenizing the surface and decreasing the number and size of pinholes and fractures in the membranes.

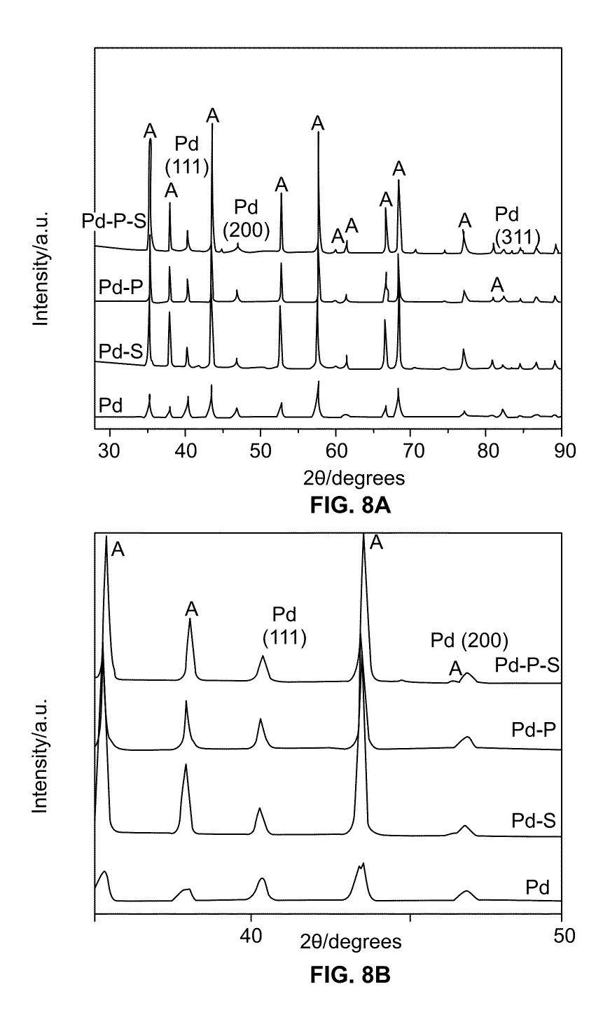

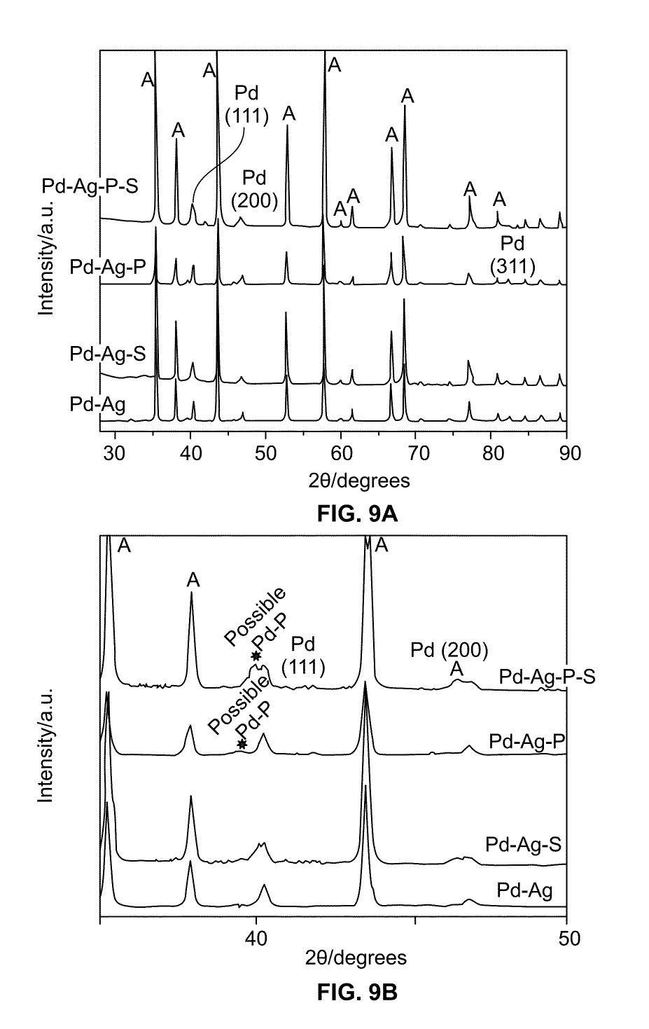

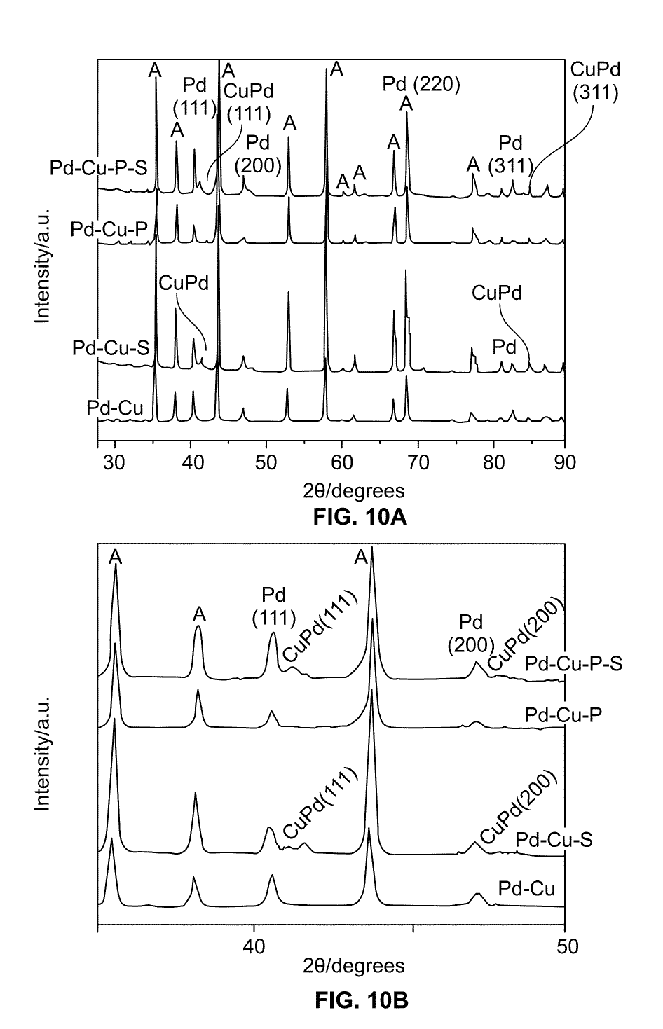

FIGS. 8-10 show the XRD diffractograms for the Pd, Pd—Ag and Pd—Cu embodiments of the present invention. In all the cases, the most intense bands correspond to the α-Al₂O₃ phase from the support (JCPDS #83-2080), marked as (A). Since this is the main phase with many intense peaks, which coincide with peaks corresponding to the other metals, it is not easy to identify the other minor phases present in the membranes. To help peak identification, expansions (shown in part (b) for each figure) are given to provide a more detailed view of the peaks at lower angles, 2θ=30-50°. The Pd system (FIG. 8) shows Pd (JCPDS #46-1043) peaks around 2θ=39.8°, 46.6°, 67.2° and 81.9° corresponding to the (111), (200), (220) and (311) crystal planes respectively of face-centered cubic (fcc) palladium, for both the Pd and the Pd—P membranes. The Pd—Ag system (FIG. 9) shows similar peaks to the Pd system. No Ag peaks are observed and the Pd peaks are slightly shifted to a lower angle, consistent with the formation of a Pd—Ag alloy. No significant differences are observed between the diffraction patterns of Pd—Ag and Pd—Ag—P. The Pd—Cu system (FIG. 10) also shows similar peaks to the ones in the other two systems. No peaks corresponding to Cu are observed, indicating that a single phase Pd—Cu alloy is formed. In this case, there are new peaks corresponding to a CuPd phase (JCPDS #48-1551) in the membranes after H₂S exposure (Pd—Cu—S and Pd—Cu—P—S). These bands are more intense in the Pd—Cu—S membrane and are broader and shifted in the Pd—Cu—P—S membrane, indicating a loss in crystallinity of the phase in the presence of P.

The XRD patterns of the samples exposed to H₂S/H₂, i.e. Pd—S, Pd—P—S, Pd—Ag—S, Pd—Ag—P—S, Pd—Cu—S, Pd—Cu—P—S shown in FIGS. 8-10, do not show the presence of any detectable amounts of Pd-sulfur compounds. The XRD patterns of a group of possible sulfur compounds were compared with the XRD patterns of these samples as shown in Table 2A.

Table 2A shows a study of the XRD patterns obtained from several membranes prepared in accordance with the present invention, contrasted with the patterns of possible Pd-sulfur and Pd-phosphorus compound candidates. Table 2A shows the values of the most intense XRD peaks and the secondary peaks corresponding to possible Pd-sulfur and Pd-phosphorus compound candidates.

TABLE 2A

| | | Main Peak/s | |
|---|---|---|---|
| | | (100% peak | Secondary Peaks (% peak |
| | Compound | intensity) | intensity) |
| Pd—S | PdS₂ | 23.61 | 25.76 (70) |
| compounds | Pd₁₆S₇ | 37.68 | 42.93 (44), 40.38 (27) |
| | Pd₃S | 35.96 | 38.14 (91), 42.73 (68), |
| | | | 44.1(64), 39.95 (54) |
| | Pd₄S | 39.49, 40.80 | 35.16 (80), 36.65 (80), 42.82 |
| | | | (80), 51.60 (80), 99.94 (80) |
| | PdS | 33.95 | 31.08 (83), 30.3 (69), 30.88 |
| | | | (69) |
| Pd—P | Pd₅P₂ | 39.35 | 32.73 (70), 42.49 (70), 42.65 |
| compounds | | | (50), 42.91 (50), 43.41 (50), |
| | | | 49.30 (50), 53.24 (50), 70.1 |
| | | | (50), 80 (50) |
| | Pd₃P_{0.8} | 39.94 | 39.61 (69), 40.41 (64), 38.52 |
| | | | (58), 38 (55), 33.42 (41), |
| | | | 43.5 (43) |
| | Pd₈P | 39.03, 39.37, 40.13, | 39.70 (70), 47.23 (70), 70 |
| | | 40.55 | (70), 71.34 (70), 72.55 (70), |
| | | | 73.20 (70), 81.67 (70), 83.84 |
| | | | (70), 84.65 (70) |
| | P₃Pd₇ | 39.89, 40.08 | 33.69 (80), 34.24 (80), 46.06 |
| | | | (80), 38.35 (60), 41.3 (60) |
| | Pd₉P₂ | 37.22, 38.68, 39.86, | 34.17 (50), 40.22 (50), 40.28 |
| | | 40.00, 42.70 | (50), 40.51 (50), 41.83 (50), |
| | | | 42.01 (50), 48.43 (50) |
| | Pd₇P₃ | 39.97 | 39.82 (70), 34.18 (54), 33.61 |
| | | | (37) |
| | Pd₆P | 39.97 | 40.68 (53), 40.55 (39), 38.1 |
| | | | (38) |
| | Pd₃P | 38.6 | 37.92 (70), 45.33 (55) |
| | Pd₁₅P₂ | 39.05 | 40.56 (87), 39.37 (66), 40.14 |
| | | | (43) |
| Other | CuPd | 41.42 | 48.21 (65), 70.54 (60), 85.30 |
| compounds | | | (50) |
| that appear | Al₂O₃ | 35.35 | 43.60 (92), 57.85 (88), 68.62 |
| in the XRD | | | (50), 37.98 (47), 52.86 (46), |
| patterns | | | 66.92 (34), 77.40 (14), 77.75 |
| | | | (8) |
| | Pd | 40.11 | 46.66 (42), 68.08 (25), 82.10 |
| | | | (24), 86.60 (8) |

Pd-Sulfur Compounds

PdS₂: Has a maximum peak at 23.61°, which does not appear in any of the patterns. Therefore this compound is not detected in any of our samples. Pd₁₆S₇: the most intense peak coincides with an alumina peak with 47% intensity. The next most intense peak appears around 42.9° (44%) but none of the XRD patterns show this peak. This compound is not detected by XRD. Pd₃S: The two most intense peaks for this compound coincide with two of the intense Al₂O₃ peaks, around 35.9 ° and 38°. The next intense peak is around 42.7° (68%), but this peak does not appear in any of the XRD patterns. There is the possibility that the compound is present in trace amounts, and therefore shows undetectable secondary peaks. Pd₄S: The most intense peaks are at 39.5° and 40.8°. These peaks appear very weakly in the patterns for Pd—Ag—S and Pd—Ag—P. Since Pd—Ag—P has not been under H₂S treatment, it is known that this sample does not contain S, and therefore this peak cannot belong to the Pd₄S compound. PdS: the most intense peaks (33.95°, 31.08°) for this compound do not coincide with the intense peaks of alumina, and they do not appear in any of the XRD patterns of the membranes.

Pd-Phosphorus Compounds

Pd₅P₂: The most intense peak is at 39.35, this peak appears in Pd—Ag—P XRD pattern and is shifted in the Pd—Ag—P—S XRD pattern. The second most intense peaks at 32.7° and 42.5° (70% intensity) do not appear in any of these XRD patterns. Pd₃P_{0.8}: The most intense peak for this compound is at 39.94° and the secondary peaks appear at 39.61° (69), 40.41° (64), all these peaks appear as weak peaks in Pd—Ag—P—S pattern. Pd₈P: the most intense peaks for this compound are 39.03°, 39.37°, 40.13°, 40.55°. These peaks are all very close to each other and could be translated into the weak peaks that appear in the region between 39-41°, all of which appear as weak peaks in the XRD patterns for Pd—Ag—P and Pd—Ag—P—S. However, the secondary peaks do not appear. This could be due to the presence of trace amounts of the compound, which makes these peaks undetectable. P₃Pd₇: The most intense peaks at 39.89° and 40.08° appear as weak peaks in the XRD patterns for Pd—Ag—P—S and Pd—Ag—P. None of the secondary peaks are detected in any of the samples. Pd₉P₂: This compound has five intense (100%) peaks going from 37.22-42.70°. These peaks do not all appear in the XRD patterns of the membranes, therefore this compound is not detected in the membranes. Pd₆P: The most intense peak at 39.97° could correspond to the peak in this region in the XRD patterns for Pd—Ag—P and Pd—Ag—P—S. The secondary peaks are not detectable in the XRD patterns for these membranes. Pd₃P: The most intense peak at 38.6° does not appear in any of the membranes' XRD patterns. This compound is not detected. Pd₁₅P₂: The most intense peaks at 39.05° and the secondary peaks could correspond to the peaks found around 39° in the XRD patterns for Pd—Ag—P and Pd—Ag—P—S.

Out of the possible sulfur compounds, Pd₁₆S₇ and Pd₃S, with most intense peaks at 2θ=37.7° and 36° respectively, are reasonable candidates and appear in trace amounts in the H₂S/H₂ treated samples. The Al₂O₃ peaks overlap the most intense peaks of these compounds, and although their secondary peaks are not observed in the diffraction patterns of the membranes, this could be due to their presence in minority amounts, making these secondary peaks undetectable.

It was also observed that the only membranes that seem to present XRD peaks that may correspond to Pd—P compounds are the membranes in the Pd—Ag system. Pd—Ag—P and Pd—Ag—P—S (FIGS. 9(a) and (b)) show broad peaks in the region of 2θ=39-41°, which is the region where the most intense peaks of a series of Pd—P compounds appear. These compounds, with the position of the corresponding most intense peaks indicated in parenthesis are: Pd₅P₂ (39.3°), Pd₃P_{0.8} (39.9°), Pd₈P (39.0°, 39.4°, 40.1°, 40.5), Pd₃P₇ (39.9°, 40.1°), Pd₆P (40.0°), Pd₁₅P₂ (39.0°). The peaks that appear at these angles in the patterns for these membranes are broad and weak, therefore they must be present in small amounts, which also explains the lack of secondary peaks. The broad peaks could be indicative of the presence of more than just one of the Pd—P compounds listed above.

Table 3 shows the atomic ratios of the surface components with respect to the total number of metal atoms (Pd+alloyed metal, i.e. Ag or Cu) in the near surface region, obtained from XPS analysis. The results were obtained both for the as-prepared membranes as for the membranes after H₂S exposure H₂ regeneration.

TABLE 3
X-ray photoelectron spectrocopy study of the surface composition of the membranes

| System | Coditions | Membrane | Pd/(Pd + metal) | Pd/(Pd + metal) | S/(Pd + metal) |
|---|---|---|---|---|---|
| Pd | As-prepared | Pd | — | — | — |
| | | Pd—F | — | 0.96 | — |
| | After H₂S + regeneration | Pd—S | — | — | 0.37 |
| | | Pd—F—S | — | 2.48 | 0.11 |
| Pd—Ag | As-prepared | Pd—Ag | 0.56 | — | — |
| | | Pd—Ag—P | 0.48 | 0.0048 | — |
| | After H₂S + regeneration | Pd—Ag—S | 0.80 | — | 0.11 |
| | | Pd—Ag—P—S | 0.86 | 0.16 | 0.017 |
| Pd—Cu | As-prepared | Pd—Cu | 0.0015 | — | — |
| | | Pd—Cu—P | 0.13 | 0.0046 | — |
| | After H₂S + regeneration | Pd—Cu—S | 0.07 | — | 0 |
| | | Pd—Cu—P—S | 0.99 | 0.19 | 0 |

In the Pd—Ag system of the present invention, the near-surface Pd composition does not vary much after adding P. In the Pd—Cu system of the present invention, the near-surface region becomes richer in Pd upon adding P in the as-prepared membranes. This indicates that P could be interacting with Pd and Cu and favoring the diffusion of Pd to the near-surface region, even though this region is still richer in Cu.

After exposure to H₂S and regeneration in H₂, the Pd—Ag and Pd—Cu alloy systems of the present invention, show a near-surface enrichment in Pd. This happens independently of the presence of P, although it is less drastic when P is present. This change is more intense in the Pd—Cu system. The effect of Pd diffusion to the surface has already been observed in studies of Pd—Cu membranes when exposed to S.

Considering that the driving force for Pd diffusion to the surface may be the formation of energetically favorable Pd—S bonds (compared to Cu—S bonds), it is understandable that in the presence of P, this diffusion happens to a lesser extent since the P that is in the surface can react with S and P—S is even more favorable energetically than Pd—S bonding.

After H₂S treatment and H₂ regeneration, the S/Pd+metal ratio decreases in the following order: Pd>Pd—Ag>Pd—Cu. For example, for the Pd membranes, the ratio decreases from 0.37 to 0.11 (Table 3), while for the Pd—Ag membranes, it decreases from 0.11 to 0.017. The amount of S that remains corresponds to the S compounds that are formed irreversibly since these samples have undergone regeneration in H₂ flow for 24 hours. It is important to note that no S is detected on the surface of the Pd—Cu membranes.

In the Pd and Pd—Ag systems of the present invention, the addition of P decreases the amount of S in the near-surface region because P partially inhibits the formation of sulfide compounds with these metals. In the Pd—Cu system of the present invention, no S is detected in the near-surface region, independently of the presence of P because no irreversible sulfide compound is formed with exposure to H₂S and it regenerates completely after being under H₂ flow, so no S is left on the surface.

The ratio of P/Pd+metal varies in the following order: Pd—P>Pd—Ag—P≅Pd—Cu—P. This ratio is higher in the pure Pd membranes compared to the Pd-alloy membranes of the present invention; therefore the structure in the alloys makes the P diffusion into the structure easier.

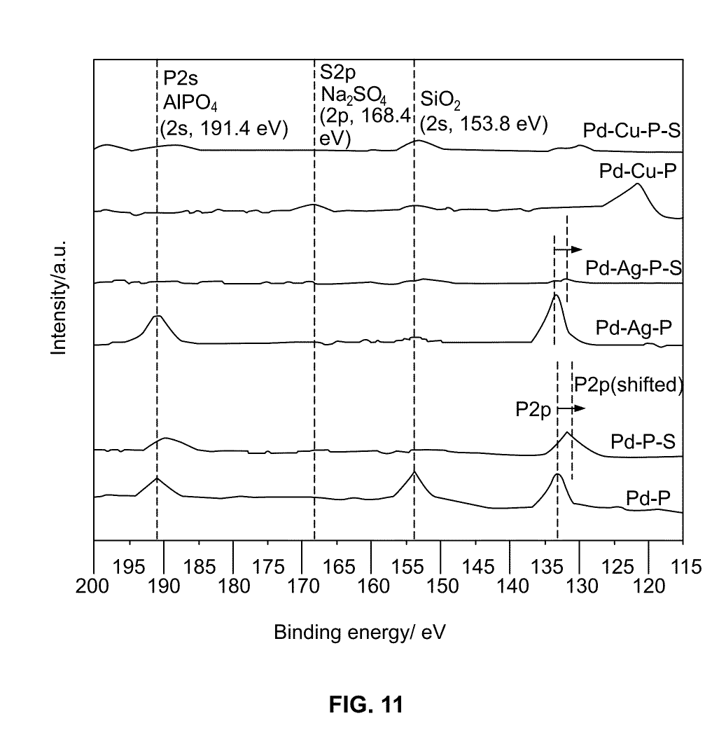

The ratio P/Pd+metal increases after H₂S exposure+H₂ regeneration for all the systems of the present invention. FIG. 11 shows the XPS spectra for all the membranes of the present invention that contain P in the region where P peaks appear. The binding energy at 191 eV is due to a P 2s transition and is typical for oxidized P such as AlPO₄ with binding energy of 191.2 eV. All energies discussed are from the NIST XPS database (HIST X-ray Photoelectron Spectroscopy Database, NIST Standard Reference Database 20, Version 4.1, 2012, Alexander V. Naumkin, Anna Kraut-Vass, Stephen W. Gaarenstroom, and Cedric J. Powell). The features at 154 eV are likely due to a SiO₂ contaminant (Si 2s 154.6 eV). The peaks between 130 and 135 eV are due to the 2p transitions of oxidized P species. For example, the 2p peak of Na₃PO₄ occurs at 133.0 eV, and that of PO(C₆H₅)₃ is found at 132.5 eV. When phosphorus is reduced, its binding energy decreases, so that the 2p peak of elemental P is at 130.1 eV. In phosphides, the binding energy is even lower so that the 2p_{1/2} peak of CrP is at 130.0 eV and that of InP is at 128.8 eV. The binding energies of S and O compounds can be understood from the electronegativities of P, S and O which respectively increase in the order 2.19, 2.58, 3.44. Thus, in compounds with oxygen, the binding energy is higher than in compounds with sulfur. For example, the 2p_{3/2} line of PO(C₆H₅)₃ is at 132.5 eV while that of PS(C₆H₅)₃ is at 130.8 eV.

In certain embodiments of the present invention, the membrane materials have a binding energy of Pd—P that is 133 eV, which goes down to 132 eV after H₂S/H₂ treatment. The initial high binding energy of PdP indicates that P is oxidized in the near-surface and the decrease after H₂S/H₂ treatment indicates that some exchange of S for O has occurred. The same occurs for Pd—Ag—P where the initial binding energy is 134 eV, which decreases to 132 eV after H₂S/H₂ treatment. From the heat of formation of PdP (−75 kJ mol⁻¹ P) and the heat of formation of P₄S₃ (−38 kJ mol⁻¹ P), the bond energy of Pd—P is higher than that of S—P.

Two processes that affect performances of the membranes of the present invention are catalytic poisoning by adsorbed sulfur compounds and corrosive decay produced by surface sulfidation. As stated above, the present invention provides membranes and composite membranes with better resistance to sulfur poisoning. Pd and Pd-alloy membranes were prepared with the novelty of adding P in the composition due to its lower probability of forming a compound with S, avoiding, therefore, the formation of corrosive compounds that would deteriorate the membrane performance.

Past studies have shown the advantages of using binary Pd alloys with other metals such as Ag and Cu to primarily suppress the α/β-palladium phase transition, but also to increase the hydrogen permeance due to the increase in the solubility and/or diffusivity of hydrogen within the alloy. In the present invention, as seen in Table 2, when comparing the performance of the as-prepared membranes, the Pd-alloy membranes do not necessarily show a higher hydrogen permeance than the Pd membrane, although they are in the same order of magnitude. For example, Pd—Ag has a slightly higher H₂ permeance (5.2×10⁻⁶ mol m⁻²s⁻¹Pa⁻¹) than Pd (4.0×10⁻⁶ mol m⁻²s⁻¹Pa⁻¹), while Pd—Cu has a lower H₂ permeance (1.1×10⁻⁶ mol m⁻²s⁻¹Pa⁻¹). The presence of P in the different embodiments decreases the hydrogen permeance in all cases and except for the Pd—Ag system, it also causes a decrease in the H₂/N₂ selectivity.

In a preferred embodiment, the Pd—Cu system of the present invention shows the best characteristics for a hydrogen-selective membrane. Both Pd—Cu and Pd—Cu—P have a relatively high H₂ permeance and H₂/N₂ selectivity (Table 2). The permeance decreases with H₂S exposure (FIG. 5), but after H₂ regeneration the Pd—Cu membrane of the present invention only recovers its hydrogen permeance partially (from 1.1×10⁻⁶ in the as-prepared membrane to 2.3×10⁻⁷ mol m⁻²s⁻¹Pa⁻¹ in the regenerated membrane). The selectivity also decreases compared to the as-prepared membrane. As explained before, the membrane poisoning by sulfur can be explained according to two effects, the adsorption of H₂S on the membrane surface which blocks active sites, and the chemical reaction of H₂S with the membrane producing a corrosion product on the surface. Studies with alloy systems have shown that when membranes undergo attack by H₂S, they usually recover at least part of their H₂ permeance when they are regenerated under hydrogen flow. The partial recovery in the systems of the present invention suggests that the H₂S poisoning involves both mechanisms and the part of the hydrogen permeance that recovers corresponds to the regeneration of the sites that were blocked due to adsorption of H₂S on the surface, whereas the part of H₂ permeance that does not recover is due to chemical attack and the irreversible formation of some sulfide compound. Although the XRD results (FIGS. 8-10) do not verify the formation of the metal sulfides, this could be due to their small particle size, below the detection limit (4 nm) and also because usually sulfur compounds segregate to the surface of the alloy and are not detectable by a bulk technique such as XRD, specially if they are present in trace amounts. XPS indicates that Pd peaks are very weak in the Pd—Cu membrane compared to the Pd—Ag system. Also the data from Table 3 indicates that the surface of the Pd—Cu membranes is richer in Cu, although after H₂S exposure there is a surface enrichment since the trend of H₂S binding strength is Cu<Pd. Only minimal sulfide compounds are formed in the Pd—Cu membrane due to diffusion of Pd atoms to the near-surface area. This would explain the absence of S on the membrane surface and the reasonably good, but not complete, membrane recovery after regeneration.

The permeance results in Table 1 reflect that after H₂ regeneration both the hydrogen permeance and the H₂/N₂ selectivity improve with respect to the as-prepared membrane. Even upon extending the exposure time to H₂S, the Pd—Cu—P membrane, of the present invention, hydrogen permeance still recovers to a value that is higher than the as prepared membrane. The X-ray diffractograms for this system of the present invention after H₂S exposure and H₂ regeneration exhibit peaks corresponding to a PdCu phase in the Pd—Cu membrane, and although these peaks also appear in the Pd—Cu—P membrane, they are broader and shifted, indicating a more amorphous character and some distortion in the PdCu phase. This could be explained by considering that P interacts with Pd and Cu atoms interfering with the formation of a distinct crystalline alloy phase composed of these two metals. XPS analysis of these membranes further corroborates this. The presence of P diminishes the extent of surface enrichment in Pd atoms after exposure to H₂S, because P interacts with the atoms and suppresses the diffusion of Pd atoms to the surface. The interaction of P with the metals is also evident from FIG. 11. None of the surface components form irreversible bonds with S since no S was detected on the surface after regeneration (Table 3). The interaction of P with Pd and Cu is suppressing the segregation of these metals and inhibiting the formation of sulfide compounds, which would explain the total recovery of the membrane permeance after regeneration under H₂ flow. SEM images clearly show that the Pd—Cu—P membrane after H₂S exposure and H₂ regeneration presents a more homogeneous surface in contrast to the Pd—Cu membrane where segregated particles are exhibited on the surface which may be the result of the segregation of Cu when sulfur atoms were deposited on a Pd—Cu alloy film and annealed under vacuum. Sulfur also cosegregated with the Cu and increased the amount of defects on the surface. The fact that Cu has lower hydrogen solubility than Pd explains the decrease in hydrogen permeance that they observed after exposure to S. In some preferred embodiments, no cracks or pinholes are formed in the Pd—Cu—P membrane this further corroborates that the membrane does not undergo surface rearrangement due to metal-sulfur interactions.

The Pd—Ag system also shows a partial recovery of the hydrogen permeance after hydrogen regeneration for both Pd—Ag and Pd—Ag—P. The percent of hydrogen permeance recovery and the H₂/N₂ selectivity are higher in the presence of P. The XRD results do not show the presence of metal sulfides in any of the cases and both membranes of the present invention show the same diffraction bands, but the partial and not complete recovery of the hydrogen permeance indicates the presence of some irreversible sulfide formation. This is in line with the XPS data, which indicate the presence of S in the Pd—Ag membranes after H₂S exposure and regeneration. The amount of S in the near-surface region is smaller when P is present in the membrane. The XRD diffraction patterns show peaks corresponding to possible minor amounts of Pd—P compounds. From the SEM images it is observed that although both membranes present pinholes after regeneration, these are much smaller in the presence of P, accounting for the higher selectivity of Pd—Ag—P. Therefore, as in the case of the Pd—Cu system, it seems that upon inserting P in the system, it interacts with the metal alloy particles suppressing the formation of metal sulfides. The fact that the selectivity is high regardless of the presence of pinholes in Pd—Ag—P indicate that the bulk of the layer maintains its integrity when exposed to H₂S and that only the top surface is damaged by sulfur poisoning.

The Pd system was studied to serve as a reference compared to the Pd-alloys. In the absence of P, as would be expected with pure palladium membranes, the membrane breaks and does not recover with hydrogen flow, as is indicated by the pinholes observed in the SEM images and by the fact that the hydrogen permeance increases compared to the as-prepared membrane while the H₂/N₂ selectivity drops drastically. On adding P to the system, the recovery with hydrogen regeneration is slightly better, however, it is much lower compared to the Pd-alloy systems. No Pd-sulfide compounds are observed by XRD neither in Pd nor in Pd—P therefore if they are formed, their particle size must be smaller than 4 nm and probably residing on the surface, as is observed through XPS.

In other embodiments, the present invention adds phosphorus to palladium-based membranes for hydrogen permeation. The addition of phosphorus is beneficial in increasing sulfur tolerance, especially in Pd-alloy systems some of which may use transition metals. In preferred embodiment, the membrane uses Pd—Ag and Pd—Cu, by interacting with the metals and producing more homogeneous surfaces and less segregation. The presence of phosphorus confers structural integrity to the membranes of the present invention that translates into a more efficient regeneration under hydrogen flow after H₂S exposure, resulting in membranes with fewer cracks and pinholes. While in the Pd and Pd—Ag system of the present invention, the recovery of the membrane after H₂S poisoning is just partial, and the presence of P seems to decrease the formation of metal-sulfide compounds, in the Pd—Cu system it suppresses their formation completely, thus avoiding irreversible corrosive poisoning of the membrane by H₂S.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiments, methods, and examples, but by all embodiments and methods within the scope and spirit of the disclosure.

What is claimed is:

1. A sulfur resistant hydrogen separation membrane, comprising:
a layer comprising palladium-phosphorus (Pd—P) or palladium-alloy-phosphorus (Pd-alloy-P).

2. The membrane of claim 1 wherein said Pd-alloy is Pd—Ag.

3. The membrane of claim 1 wherein said Pd-alloy is Pd—Cu.

4. The membrane of claim 1 wherein said phosphorus decreases the formation of sulfides.

5. The membrane of claim 1 wherein said phosphorus increases the homogeneity of the membrane surface and decreases the particle size of the surface components.

6. The membrane of claim 1 wherein said phosphorus suppresses the diffusion of palladium atoms to the surface of said membrane.

7. The membrane of claim 1 wherein said phosphorus is phosphine, PH₃ or diphosphine (P₂H₄), or red phosphorus, or a phosphate or phosphite compound, or an organic phosphine compounds such as trimethylphosphine, tryvinylphosphine, triphenyphosphine, or octyl phosphine.

8. The Pd—P membrane of claim 1 having a H₂ permeance of at least 1×10⁻⁶ mol m⁻²s⁻¹Pa⁻¹ and a H₂/N₂ selectivity of at least 100 at between 473 K and 873 K.

9. The Pd—Ag—P membrane of claim 2 having a H₂ permeance of at least 5×10⁻⁶ mol m⁻²s⁻¹Pa⁻¹ and a H₂/N₂ selectivity of at least 50 at between 473 K and 873 K.

10. The Pd—Cu—P membrane of claim 3 having a H₂ permeance of at least 1×10⁻⁶ mol m⁻²s⁻¹Pa⁻¹ and a H₂/N₂ selectivity of at least 100 at between 473 K and 873 K.

11. A method of making palladium-phosphorus or palladium-alloy-phosphorus membranes for hydrogen separation consisting of contacting said Pd or Pd-alloy of said membranes with a phosphorus source.

12. The method of claim 14 wherein said phosphorus is phosphine, PH₃ or diphosphine (P₂H₄), or red phosphorus, or a phosphate or phosphite compound, or an organic phosphine compounds such as trimethylphosphine, tryvinylphosphine, triphenyphosphine, or octyl phosphine.

13. The method of claim 14 wherein said phosphorus increases the homogeneity of the membrane surface and decreases the particle size of the surface components.

14. The method of claim 14 wherein said phosphorus reduces pinholes in the surface of the membrane.
